(19) United States
(12) Patent Application Publication
(10) Pub. No.: US 2016/0377145 A1
(43) Pub. Date: Dec. 29, 2016

(54) SHAFT WITH ADJUSTABLE RIGIDITY

(71) Applicant: AVL LIST GMBH, Graz (AT)

(72) Inventors: Martin Wetzel, Graz (AT); Joachim Schmidt, Werndorf (AT)

(73) Assignee: AVL LIST GMBH, GRAZ (AT)

(21) Appl. No.: 15/121,253

(22) PCT Filed: Mar. 10, 2015
(86) PCT No.: PCT/EP2015/054905

§ 371 Date: Aug. 24, 2016

(30) Foreign Application Priority Data
Mar. 21, 2014 (AT) A 50205/2014

(51) Int. Cl. F16F 15/126; F16F 15/121; F16D 3/72

(52) U.S. Cl. CPC F16F 15/126; F16D 3/72; F16F 15/1216

(57) ABSTRACT

The invention relates to shaft (1) with adjustable stiffness, wherein at least one torsion bar (2), which is surrounded by a tubular sleeve (3), is arranged between a first shaft attachment (8) and a second shaft attachment (15), wherein at least one shaft attachment (8) is arranged at a first end (2a) of the torsion bar (2), and wherein preferably at least one first damping element (4a, 4b, 4c) is arranged between the tubular sleeve (3) and the torsion bar (2), wherein the tubular sleeve (3) can be connected in a rotationally fixed and releasable manner at at least one end (11, 16) to the torsion (2) bar by means of at least one connection element (10, 20, 30). In order to permit, in the simplest possible manner, a durable but when necessary variable adjustability of the torsional stiffness in order to match the rotational oscillation behaviour, it is provided that the first shaft attachment (8) is formed by a first connection flange (7) which can be connected in a rotationally fixed and releasable manner to a corresponding first counter-flange (9) in the region of the first end (11) of the tubular sleeve (3) by means of at least one first connection element (10) preferably formed by at least one screw connection.

The invention relates to a shaft with adjustable stiffness, wherein at least one torsion bar, which is surrounded by a tubular sleeve, is arranged between a first shaft attachment and a second shaft attachment, wherein one shaft attachment is arranged at a first end of the torsion bar, and wherein preferably at least one damping element is arranged between the tubular sleeve and the torsion bar, wherein the tubular sleeve can be connected in a rotationally fixed and releasable manner at at least one end to the torsion bar by means of at least one connection element. The invention further relates to a method for setting different torsional stiffnesses.

A torsionally elastic, length-adjustable cardan shaft is known from CH 937 344 A, which consists of at least two parts which are displaceably axially guided with respect to each other. The two shaft parts are connected to each other in a longitudinal adjustable manner via torsion spring bars extending parallel to the longitudinal axis of the shaft, wherein the torsion spring bars are mounted in an axially displaceable manner with one end in adjacent shaft parts.

DE 10 002 259 A1 describes a torque transmission device for a drive train of a motor vehicle with an axially elastic component. In a predetermined radial region of the disc-shaped or ring-disc shaped elastic component, a number of dissections which correspond to an axial stiffness to be set and which are distributed over the circumference are introduced. Such dissections limit the flexural stiffness in the axial direction as a result of the reduced effective surface area of the disc-shaped component in the radial direction, so that the number of said dissections is capable of achieving a variation in the axially effective stiffness ranging from a virtually unchanged behaviour in very few dissections up to a very low axial stiffness in a virtually completely dissected circumference with only very few remaining webs which assume the flexural stiffness in the radial direction. It is disadvantageous that the dissections lead to a substantially irreversible fixed setting of the torsional stiffness.

DE 10 2008 035 488 A1 describes a drive shaft with a central element and a tubular sleeve, wherein the central element and the tubular sleeve are connected to each other in a torsion-proof manner in a first region and are connected to each other via a damping element in a second region which is spaced from the first region in the longitudinal direction of the drive shafts. The connection in the first region is formed in a rigid and unchangeable manner, so that the torsional stiffness is fixedly predetermined.

A shaft with adjustable stiffness is known from AT 506 732 A1, wherein at least one torsion bar is arranged between a first shaft section and a second shaft section. The shaft has a smaller diameter in the region of the torsion bar than in the region of the first and second shaft sections. The shaft further comprises at least one axially displaceable tubular sliding sleeve, wherein the first and the second shaft section of the shaft can be connected to each other by the sliding sleeve in a first position and can be separated in a second position. As a result, the stiffness for adjusting the torsional vibration behaviour can be changed repeatedly, wherein inadvertent displacement of the sliding sleeves and thus unintended adjustment of the torsional stiffness during operation cannot be excluded.

DE 10205932 A1 describes a transverse stabiliser for a motor vehicle, which consists of a torsion bar and a tubular sleeve. The torsional stiffness of the transverse stabiliser can be set via a jaw clutch. The claws between the flanges lead to high torsional stiffness in the engaged state and to low torsional stiffness in the disengaged state.

U.S. Pat. No. 1,965,742 A discloses a shaft consisting of a torsion bar and a tubular sleeve, which are slidingly connected via a disc clutch.

A stabiliser for motor vehicles with variable torsional stiffness is known from JP 2006/017 194 A. The stabiliser comprises a torsion bar and a tubular sleeve, between which damping elements are arranged. The torsion bar and the tubular sleeve can be pretensioned against each other by pressurisation of a chamber and by displacing a wedge-shaped component, thus increasing the torsional stiffness.

DE 10 2007 058 764 A1 shows a stabiliser for motor vehicles with a torsion bar and a tubular sleeve, which can be connected to each other in a torsion-proof manner by couplings at both ends of the tubular sleeve, by means of which different torsional stiffnesses can be realised.

A damping device with a torsion bar and a tubular sleeve is known from U.S. Pat. No. 5,413,318 A, wherein spring elements are arranged between the torsion bar and the tubular sleeve. The spring elements can be pretensioned by pressurisation, as a result of which the damping body is pretensioned with the central tube and the natural frequency of the system is thus changed.

AT 507 923 B1 describes a shaft connection with at least two torsional elements, of which one is formed torsion bar, which is rotationally connected at one end to a first shaft attachment and at a second end to a second shaft attachment. The torsional stiffness of the torsion bar can be changed via an actuator.

US 2013/0300043 A1 discloses a torsion spring consisting of a torsion bar and a tubular sleeve, which are coupled to each other via a disc. The disc is fixedly bolted to the torsion bar and coupled to the tubular sleeve via a pin and a slot from a specific relative angle between the torsion bar and the tubular sleeve.

It is the object of the invention to provide a shaft connection in which different torsional stiffnesses can be set permanently, but still variably.

This is achieved in accordance with the invention in such a way that the first shaft attachment is formed by a first connection flange which can be connected in a rotationally fixed and releasable manner to a corresponding first counter-flange in the region of the first end of the tubular sleeve by means of at least one first connection element preferably formed by at least one screw connection, wherein preferably the flange surfaces of the first flange and the first counter-flange are arranged normally to the longitudinal axis of the shaft.

In order to enable variably setting the torsional stiffnesses and still allowing the setting as such, it is advantageous if the first connection flange can be connected in an interlocking manner to the corresponding first counter-flange. “Permanent” means in this connection that automatic inadvertent adjustment of the torsional stiffness in operation is prevented. Any change to the setting of the torsional stiffness is reversible. As a result of the interlocking connection however, torsional stiffnesses from earlier settings can be brought back again.

It is especially advantageous if the second shaft attachment is formed by a second connection flange which can rotationally be connected to a corresponding second counter-flange in the region of a second end of the tubular sleeve and/or to a flange at the second end of the torsion bar via at least one releasably connectible second and/or third connection element which is formed by at least one screw connection and is rigidly connected to the connection flange on the one hand and the tubular sleeve or the flange at the second end of the torsion bar on the other hand. In this respect, at least two mutually facing flange surfaces of the second connection flange can be arranged normally to the longitudinal axis of the shaft.

In this respect, the largest number of possible variations of different torsional stiffnesses can be realised when the second connection flange is formed separately from the tubular sleeve and the torsion bar, and is preferably rotationally mounted on the torsion bar.

A damping element can be arranged for additional damping of torsional oscillations between the second counter-flange and the second connection flange.

At least one connection element is required for the transmission of torque between the two shaft attachments of the shaft, which connection element rotationally connects the second connection flange to the flange of the torsion bar at its second end for example. An increase in the stiffness can be achieved by a second connection element between the first connection flange and the first counter-flange and/or the second connection flange and the second counter-flange, wherein a single connection element can also rotationally connect the second counter-flange, the second connection flange and the flange at the second end of the torsion bar. A further switching possibility is obtained in that the first connection flange is rigidly rotationally connected via a first connection element to the first counter-flange and the second connection flange to the second counter-flange via a respective connection element.

Inadvertent adjustment of the torsional stiffness is prevented in such a way that the connection elements are formed by screw connections.

The invention will be explained below in closer detail by reference to the enclosed drawings, wherein:

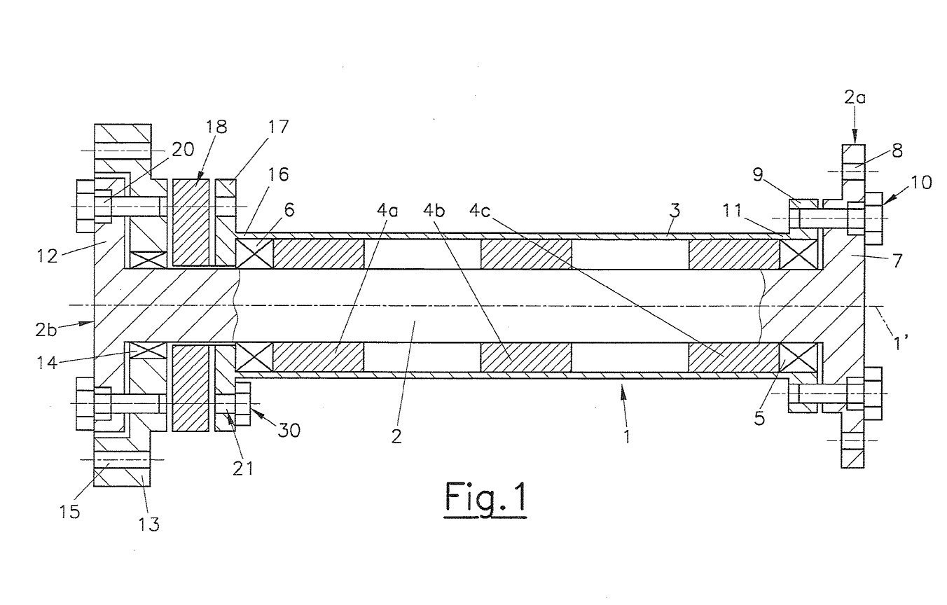

FIG. 1 shows a shaft in accordance with the invention in a longitudinal sectional view, and

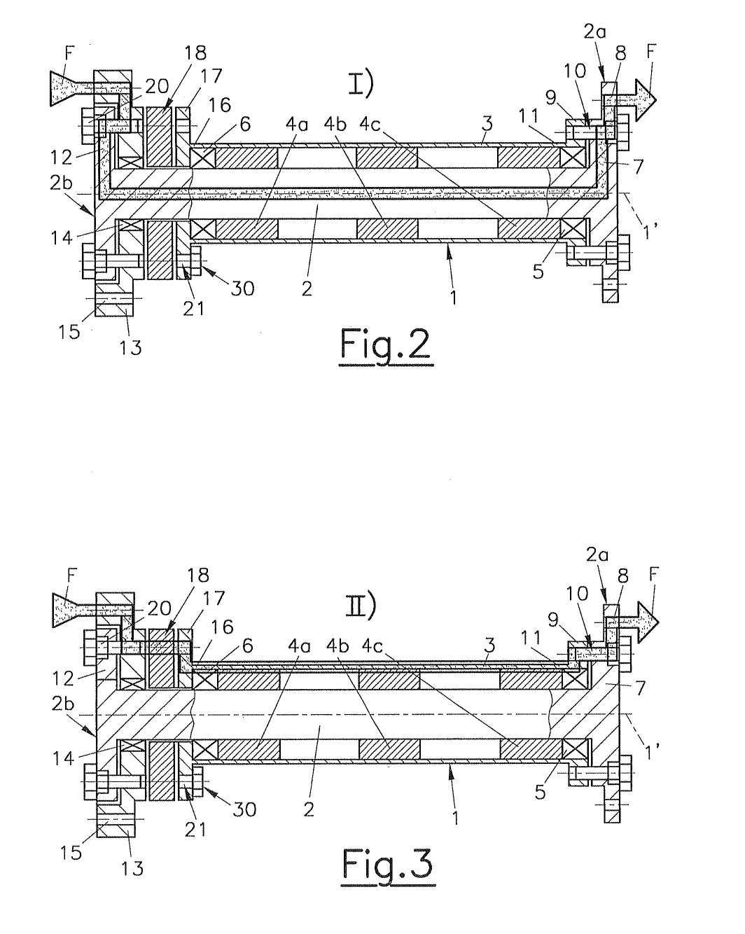

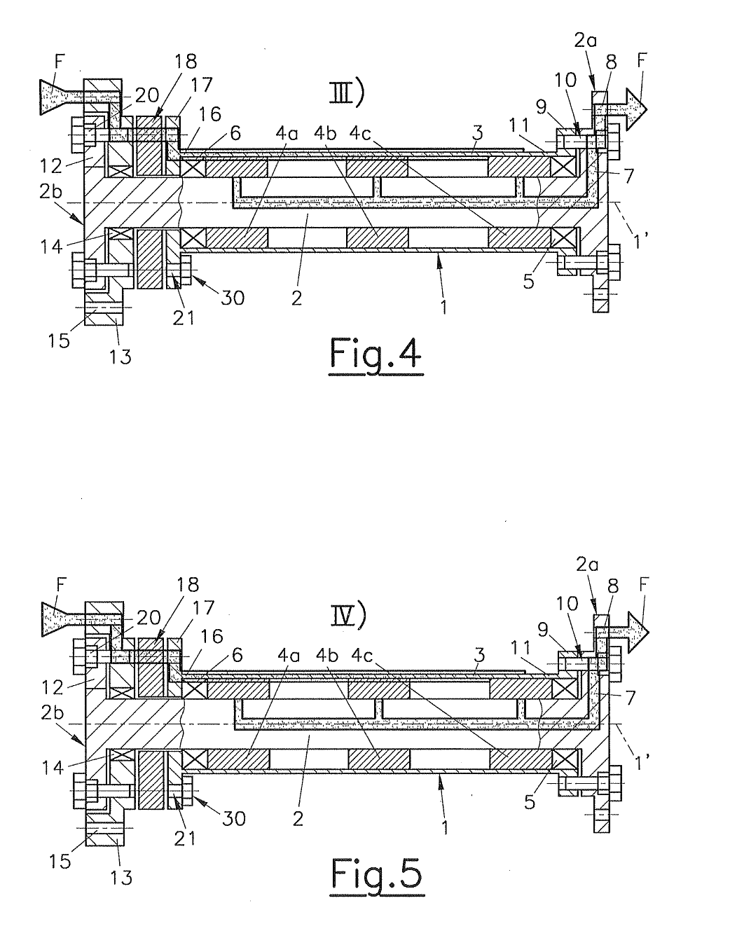

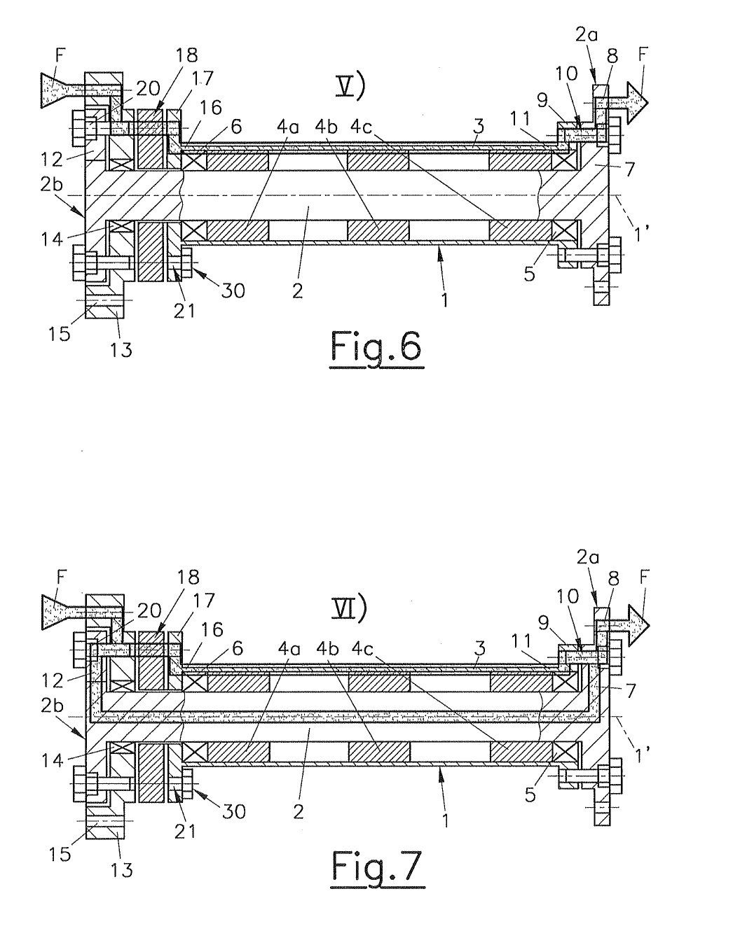

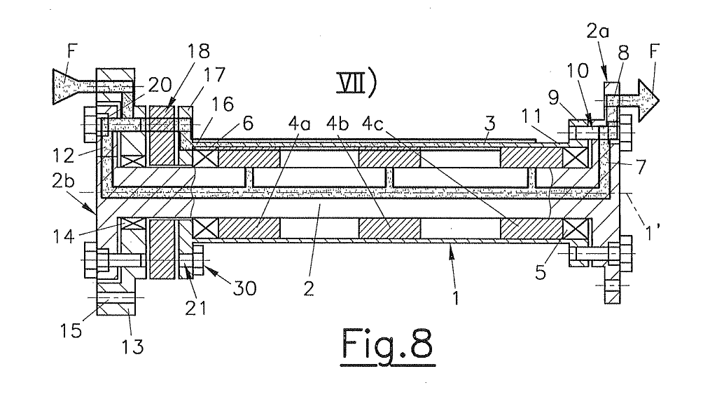

FIGS. 2 to 8 show the power flow through the shaft at the differently set torsional stiffnesses.

The drawings each show a shaft 1, e.g. a connection shaft between a motor and a loading unit on the test stand, with variable stiffness. The shaft 1 comprises a torsion bar 2, which is surrounded by a tubular sleeve 3, wherein first damping elements 4a, 4b, 4c are arranged between the tubular sleeve 3 and the torsion bar 2. Bearings 5, 6 are optionally provided between the torsion bar 2 and the tubular sleeve 3.

The torsion bar 2 comprises a first connection flange 7 at a first end 2a, which forms a first shaft attachment 8 for a connection shaft (not shown in closer detail). The first connection flange 7 can be connected via at least one first connection element 10 to a first counter-flange 9 in the region of a first end 11 of the tubular sleeve 3, wherein the connection elements 10 can be formed by a screw connection for example.

The torsion bar 2 comprises a flange 12 at the second end 2b which faces away from the first connection flange 7, which flange adjoins a second connection flange 13 which is rotationally mounted on the torsion bar 12 via a bearing 14.

The second connection flange 13 forms a second shaft attachment 15 for a connection shaft (not shown).

The tubular sleeve 3 comprises a second counter-flange 17 at a second end 16 which is opposite the first end 11, wherein at least one second damping element 18 is arranged between the second counter-flange 17 and the second connection flange 13. The damping element 18, which is formed as a disc, can permanently be bolted together with the connection flange 13 (not shown in the drawing).

The flange 12 of the torsion bar 2 can rotationally be connected via at least one second connection element 20 to the second connection flange 13.

The second counter-flange 17 can rotationally be connected via at least one third connection element, which is indicated with the reference numeral 30 and is formed by a connection screw 21 for example, to the second damping element 18 and optionally also to the second connection flange 13.

Different torsional stiffnesses in the shaft 1 can be realised by different application and combination of the first, second and third connection elements 10, 20, 30 which are formed by screw connections for example. The power flow F through the shaft is indicated in FIGS. 2 to 8 for the following variants I) to VII). The path of the power flow for these variants is described below:
I) Power flow F: 15->13->20->12->2->7->8
   Screwed connection elements: 20
   Open connection elements: 10, 30
   The second connection element 20 is used for connecting the second connection flange 13 to the flange 12;
II) Power flow F: 15->13->18->30->17->3->9->10->7->8
   Screwed connection elements: 10, 30
   Open connection elements: 20
   The first connection element 10 is used for connecting the first connection flange 7 to the first counter-flange 9,
   the third connection element 30 is used for connecting the second counter-flange 17 to the second damping element 18;
III) Power flow F: 15->13->18->30->17->3->4a, 4b, 4c->2->7->8
   Screwed connection elements: 30
   Open connection elements: 10, 20
   The third connection element 30 is used for connecting the second counter-flange 17 to the second damping element 18;
IV) Power flow F: 15->13->30->17->3->4a, 4b, 4c->2->7->8
   Screwed connection elements: 30 long to 13
   Open connection elements: 10, 20
   The third connection element 30, which is formed in a “long” manner, is used for connecting the second counter-flange 17 to the second damping element 18 and also to the second connection flange 13;
V) Power flow F: 15->13->30->17->3->9->10->7->8
   Screwed connection elements: 10, 30 long to 13
   Open connection elements: 20
   The first connection element 10 is used for connecting the first connection flange 7 to the first counter-flange 9,
   the third connection element 30, which is formed in a “long” manner, is used for connecting the second counter-flange 17 to the second damping element 18 and also to the second connection flange 13;
VI) Power flow F: 15->13->20->12->2->7->8
   15->13->18->30->17->3->9->10->7->8
   Screwed connection elements: 10, 20, 30
   Open connection elements:
   The first connection element 10 is used for connecting the first connection flange 7 to the first counter-flange 9,
   the second connection element 20 is used for connecting the second connection flange 13 to the flange 12,
   the third connection element 30 is used for connecting the second counter-flange 17 to the second damping element 18;
VII) Power flow F: 15->13->20->12->2->7->8
   15->13->18->30->17->3->4a, 4b, 4c->2->7->8
   Screwed connection elements: 20, 30
   Open connection elements: 10
   The second connection element 20 is used for connecting the second connection flange 13 to the flange 12,
   the third connection element 30 is used for connecting the second counter-flange 17 to the second damping element 18;

The lowest torsional stiffness can presumably be achieved in variant I, and the highest torsional stiffness in variant V with rigid connection of the connection flange 13 and the second counter-flange 17 and further on the first connection flange 7.

All three connection elements 10, 20, 30 can be realised by screw connections, as a result of which a permanent torsional stiffness can be set, but which can still be changed if necessary.

1-10. (canceled)

11. A shaft with adjustable stiffness, wherein at least one torsion bar, which is surrounded by a tubular sleeve, is arranged between a first shaft attachment and a second shaft attachment, wherein at least one shaft attachment is arranged at a first end of the torsion bar, and wherein preferably at least one first damping element is arranged between the tubular sleeve and the torsion bar, wherein the tubular sleeve can be connected in a rotationally fixed and releasable manner at at least one end to the torsion bar by means of at least one connection element, wherein the first shaft attachment is formed by a first connection flange which can be connected in a rotationally fixed and releasable manner to a corresponding first counter-flange in the region of the first end of the tubular sleeve by means of at least one first connection element.

12. The shaft according to claim 11, wherein the flange surfaces of the first connection flange and the first counter-flange are arranged normally to the longitudinal axis of the shaft.

13. The shaft according to claim 11, wherein the first connection flange can be connected in an interlocking manner to the corresponding first counter-flange.

14. The shaft according to claim 11, wherein said at least one first connection element is formed by at least one screw connection.

15. The shaft according to claim 11, wherein the second shaft attachment is formed by a second connection flange which can be connected in a rotationally fixed and releasable manner to a corresponding second counter-flange in the region of the second end of the tubular sleeve and/or to a flange at the second end of the torsion bar via at least one second and/or third connection element.

16. The shaft according to claim 15, wherein at least two mutually facing flange surfaces of the second connection flange and the counter-flange are arranged normally to the longitudinal axis of the shaft.

17. The shaft according to claim 15, wherein a second damping element is arranged between the second counter-flange and the second connection flange.

18. The shaft according to claim 17, wherein the second damping element is connected in a rotationally fixed manner to the connection flange.

19. The shaft according to claim 15, wherein the second connection flange is formed separately from the tubular sleeve and the torsion bar.

20. The shaft according to claim 19, wherein the second connection flange rotationally mounted on the torsion bar.

21. The shaft according to claim 15, wherein said second or third connection element which is formed by at least one screw connection.

22. A method for setting different torsional stiffnesses in a shaft according to claim 11, wherein at least one torsion bar, which is surrounded by a tubular sleeve, is arranged between a first shaft attachment and a second shaft attachment, wherein at least one shaft attachment is arranged at a first end of the torsion bar, and wherein the tubular sleeve is connected in a rotationally fixed and releasable manner at at least one end to the torsion bar by means of at least one connection element, wherein a first connection flange which forms the first shaft attachment is connected in a rotationally fixed and releasable manner to a corresponding first counter-flange in the region of the first end of the tubular sleeve via at least one first connection element.

23. The method according to claim 22, wherein a second connection flange which forms the second shaft connection is connected in a rotationally fixed and releasable manner to a corresponding second counter-flange in the region of the second end of the tubular sleeve and/or to a flange at the second end of the torsion bar via at least one second and/or third connection element.

24. The method according to claim 22, wherein the first connection flange is connected in an interlocking manner to the corresponding first counter-flange.

25. The method according to claim 22, wherein at least one first damping element is arranged between the tubular sleeve and the torsion bar.

26. The method according to claim 22, wherein the tubular sleeve and the torsion bar are bolted together.

27. The method according to claim 22, wherein the first connection element is formed by at least one screw connection.

28. The method according to claim 22, wherein the second connection flange is bolted to the corresponding second counter-flange.

29. The method according to claim 22, wherein the second or third connection element is formed by at least one screw connection.
